(19) United States
(12) Patent Application Publication
(10) Pub. No.: US 2024/0180195 A1
(43) Pub. Date: Jun. 6, 2024

(54) MEAT-LIKE FOOD PRODUCT

(71) Applicant: MORINAGA & CO., LTD., Tokyo (JP)

(72) Inventors: Masahiko SAI, Kanagawa (JP); Takahiro YAMAGUCHI, Kanagawa (JP); Kenichi MORITA, Kanagawa (JP)

(73) Assignee: MORINAGA & CO., LTD., Tokyo (JP)

(21) Appl. No.: 18/286,041

(22) PCT Filed: Apr. 7, 2022
(86) PCT No.: PCT/JP2022/017304

§ 371 Date: Oct. 6, 2023

(30) Foreign Application Priority Data
Apr. 7, 2021 (JP) 2021-065493

(51) Int. Cl. A23J 3/26; A23J 3/16; A23J 3/18; A23J 3/22

(52) U.S. Cl. CPC A23J 3/26; A23J 3/16; A23J 3/18; A23J 3/227

(57) ABSTRACT

The present invention is directed to provide a meat-like food product having good food texture and being free of meat. The meat-like food product is produced by a method for producing a meat-like food product. The method includes an extrusion molding a kneaded product using an extruder while forcibly cooling to thereby produce an extrusion-molded product. The kneaded product is produced by kneading water and a raw material containing a protein while heating. In the extrusion molding, the extrusion-molded product is forcibly cooled when discharged from the extruder such that the temperature of a central portion of the extrusion-molded product is in a range from 110° ° C. to 125° C. The water content of the extrusion-molded product is from 45 mass % to 60 mass % with respect to the total mass of the extrusion-molded product.

### TECHNICAL FIELD

The present invention relates to a meat-like food product.

### BACKGROUND ART

A demand exists for a meat-like food product that contains a plant protein such as soybeans or wheat and can be used as a meat substitute.

The development of meat-like food products using plant proteins is mainly carried out using equipment called an extruder.

For example, Patent Document 1 discloses a method for producing a textured protein material by kneading a plant-derived protein material, starch, calcium acetate, and water, and extruding the mixture through a die under high temperature and high pressure conditions into normal pressure environment using an extruder.

Moreover, Patent Document 2 indicates that a textured protein material having a meat-like fibrous feel can be produced by making cut grooves in a textured protein material produced using an extruder.

### CITATION LIST

### Patent Literature

Patent Document 1: JP 2019-135923 A
Patent Document 2: JP 2018-164459 A

### SUMMARY OF INVENTION

### Technical Problem

Incidentally, meat-like food products produced using an extruder can be largely classified into low-water content type products and high-water content type products according to the amount of water in the meat-like food product after being discharged from the extruder.

A low-water content type product is prepared by blending water into a protein serving as a raw material, passing the mixture through an extruder to cause the protein to expand, and then generally drying the expanded protein. At the time of use, the low-water content type product is reconstituted with water or hot water and then used in cooking.

On the other hand, a high-water content type product is prepared by blending water into a protein serving as a raw material, extruding the mixture, and cooling with a cooling die when the mixture is discharged to thereby produce a dense structure without expansion.

With regard to these tissues, the low-water content type product has a sponge-like tissue, whereas the high-water content type product has a dense fibrous tissue extending along the discharge direction of the extruder.

Further, as for cooking properties and storage properties, the low-water content type product is in a sponge-like form, and therefore water and seasoning liquids easily permeate the product. The product also exhibits excellent storability when dried.

First to third aspects of the invention disclosed in the present specification are directed to provide a meat-like food product having a novel tissue and texture, which is different from the related art.

In addition, a fourth aspect of the invention disclosed in the present specification is directed to provide a meat-like food product with improved flavor.

### Solution to Problem

The present inventors discovered that by adjusting the temperature and water content of a central portion of an extrusion-molded product discharged from an extruder, a discontinuous portion in which fibers are separated from each other can be formed in a dense fibrous tissue that is characteristic of known high-water content type meat-like food products.

In response to the above issue, a first aspect of the present invention is provided as follows.

A method for producing a meat-like food product that is free of meat, the method including:
extrusion molding a kneaded product using an extruder while forcibly cooling to thereby produce an extrusion-molded product, the kneaded product being produced by kneading water and a raw material containing a protein while heating,
wherein,
in the extrusion molding, the extrusion-molded product is forcibly cooled when discharged from the extruder such that a temperature of a central portion of the extrusion-molded product is in a range from 110° C. to 125° C., and
the water content of the extrusion-molded product is from 45 mass % to 60 mass % with respect to the total mass of the extrusion-molded product.

Through such an aspect, the meat-like food product to be produced has a fibrous tissue as a whole but can have a discontinuous portion formed therein. Furthermore, due to the presence of the discontinuous portion, softness and a sense of crumbling attributed to the occurrence of layer displacement within the tissue when chewed can be imparted.

In addition, in a preferred embodiment of the present invention, in the extrusion molding, the kneaded product is heated such that a maximum product temperature of the kneaded product is from 145° ° C. to 180° C.

In a preferred embodiment of the present invention, the water content of the kneaded product is from 45 mass % to 70 mass % with respect to the total mass of the kneaded product.

In a preferred embodiment of the present invention, the ratio of a protein content to a solid content in the kneaded product is from 45 mass % to 90 mass %.

In a preferred embodiment of the present invention, the ratio of the content of starch to the solid content in the kneaded product is from 5 mass % to 20 mass %.

In a preferred embodiment of the present invention, the protein is a plant protein.

In a preferred embodiment of the present invention, the plant protein is soybean protein and/or wheat protein.

In a preferred embodiment of the present invention, in the extrusion molding, the kneaded product is molded into an oriented fibrous tissue, and the oriented fibrous tissue is expanded to thereby form, inside the oriented fibrous tissue, a discontinuous portion in which fibers are separated from each other and a tightly adhered portion in which fibers are tightly adhered with each other, and the tightly adhered portion is around the discontinuous portion, and the discontinuous portion extends along the fiber direction.

In response to the above issue, a second aspect is provided as follows.

A meat-like food product being free of meat,
wherein
a tissue of the meat-like food product is an oriented fibrous tissue,
the tissue includes:
a discontinuous portion in which fibers are separated from each other; and
a tightly adhered portion in which fibers are tightly adhered with each other, the tightly adhered portion being around the discontinuous portion, and
the discontinuous portion extends along a fiber direction.

While the meat-like food product having the above-mentioned structure has a meat-like fibrous tissue as a whole, because of the presence of the discontinuous portions, the meat-like food product also exhibits softness and a sense of crumbling caused by layer displacement in the tissue when chewed, and because of the presence of the tightly adhered portion, the meat-like food product also exhibits chewiness, and thus has a food texture (chewing comfort) similar to that of meat as a whole.

In addition, the presence of the discontinuous portion provides an additional effect of facilitating the permeation of a seasoning liquid.

Further, in a preferred embodiment of the present invention, the tightly adhered portion includes a portion having a thickness from 3 mm to 25 mm in the thickness direction of the meat-like food product.

In a preferred embodiment, the above-mentioned portion is present between the surface of the meat-like food product and the discontinuous portion, and between the discontinuous portions.

In a preferred embodiment of the present invention, the meat-like food product has a thickness from 6 mm to 50 mm.

In a preferred embodiment of the present invention, when the meat-like food product is observed in a cross section in a direction perpendicular to the fiber direction, a ratio of the discontinuous portions having a major axis of 3 mm or greater in the cross section among all the discontinuous portions having a major axis of 0.5 mm or greater in the cross section is 10% or greater.

In a preferred embodiment of the present invention, the meat-like food product includes the discontinuous portion having a major axis of 7.5 mm or greater in a cross section in a direction perpendicular to the fiber direction of the meat-like food product when the meat-like food product is observed in the cross section.

In a preferred embodiment of the present invention, the meat-like food product includes a plurality of the discontinuous portions.

In a preferred embodiment of the present invention, the meat-like food product is extrusion-molded by an extruder.

In a preferred embodiment of the present invention, the discontinuous portion is a void.

In a preferred embodiment of the present invention, the discontinuous portion is formed through expansion during extrusion molding by the extruder.

In addition, the discontinuous portion may be formed by making a cut inside the oriented fibrous tissue.

Moreover, the discontinuous portion may be formed by laminating two or more protein sheets and partially adhering surfaces of the two or more protein sheets to each other.

Furthermore, in a preferred embodiment of the present invention, the meat-like food product has an average value that satisfies at least one of (A) to (D) with the average value being obtained by measuring two or more different points by the following method using a Tensipresser (trade name):
(A) a breaking stress (tenderness) is from 10000 gw/cm² to 47000 gw/cm²;
(B) a total workload (toughness) is from 5000 gw/cm² to 15300 gw/cm²;
(C) a pliability is from 0.5 to 2.1; and
(D) a brittleness is from 1.3 to 3.5,
provided that the measuring of the two or more different points is performed according to the following method and conditions:

Sample thickness: a sample is prepared such that the thickness in the direction perpendicular to the fiber direction is 15 mm,
Plunger: cylindrical with diameter φ of 5 mm,
Bite Speed: 2.00 mm/sec,
Second Speed: 2.00 mm/sec,
Plansure Area: 0.041 cm²,
Add Value: 0.100 mm,
Measurement temperature: 20° C., and
Measurement method: multiple integration bite method.

In response to the above issue, a third aspect of the present invention is provided as follows.

A meat-like food product being free of meat,
wherein an average value obtained by measuring two or more different points using a Tensipresser satisfies at least one of (A) to (D):
(A) a breaking stress (tenderness) is from 10000 gw/cm² to 47000 gw/cm²;
(B) a total workload (toughness) is from 5000 gw/cm² to 15300 gw/cm²;
(C) a pliability is from 0.5 to 2.1; and
(D) a brittleness is from 1.3 to 3.5.
provided that the measuring of the two or more different points is performed according to the following method and conditions:
Sample thickness: thickness in a direction perpendicular to the fiber direction is 15 mm,
Plunger: cylindrical with diameter q of 5 mm,
Bite Speed: 2.00 mm/sec,
Second Speed: 2.00 mm/sec,
Plansure Area: 0.041 cm²,
Add Value: 0.100 mm,
Measurement temperature: 20° ° C., and
Measurement method: multiple integration bite method.

The meat-like food product having such physical properties exhibits good texture.

Moreover, in a preferred embodiment of the present invention, at least two of (A) to (D) are satisfied.

In a preferred embodiment of the present invention, the tissue of the meat-like food product is an oriented fibrous tissue, and the meat-like food product has a water content of 50 mass % or greater.

In response to the above issue, a fourth aspect of the present invention is provided as follows.

A method for producing a meat-like food product that is free of meat, the method including:
extrusion molding a kneaded product using an extruder to thereby produce an extrusion-molded product, the kneaded product being produced by kneading water and a raw material containing a protein while heating,
wherein
the raw material is an extrusion-molded product produced using an extruder.

Through this, an undesirable flavor derived from the protein raw material can be reduced.

In a preferred embodiment of the present invention, the extrusion molding is carried out twice or more, and
the raw material in the second and subsequent extrusion molding is the extrusion-molded product produced in the previous extrusion molding.

By repeating the extrusion molding with the extruder, the undesirable flavor derived from the protein raw material can be further reduced.

In a preferred embodiment of the present invention, the final extrusion molding is carried out such that the water content of the extrusion-molded product is from 45 mass % to 60 mass %.

Moreover, the raw material preferably has a water content of 45 mass % or less. In addition, the raw material is preferably an extrusion-molded product produced through an extruder process in which the maximum product temperature of the kneaded product is 130° C. or higher.

Further, in a preferred embodiment of the present invention, washing and dehydrating the raw material is included before the extrusion molding.

By including washing and dehydrating the extrusion-molded product, the undesirable flavor derived from the protein raw material can be further reduced. As a result, it is not necessary to apply a strong flavoring or the like in order to mask an undesirable flavor, and the range of seasoning and cooking is widened.

Here, an embodiment obtained by combining the preferred embodiments of the first aspect and the fourth aspect (invention of the manufacturing method) is also preferable.

In addition, an embodiment in which the preferred embodiments of the second aspect and the third aspect (invention of a product) are combined is also preferable.

### Advantageous Effects of Invention

According to the first to third aspects of the present invention, a meat-like food product having a good food texture can be provided. In a particularly preferred embodiment, a meat-like food product having a chicken-like texture can be provided.

According to the fourth aspect of the present invention, a meat-like food product having improved flavor can be provided.

Further, according to a combination of the aspects, a meat-like food product having a good food texture and an improved flavor can be provided.

### BRIEF DESCRIPTION OF DRAWINGS

FIG. 1 is a photograph of a cross section of the meat-like food product of an embodiment of the present invention cut in a direction perpendicular to the fiber direction.

FIG. 2 is a photograph of a cross section of the meat-like food product of an embodiment of the present invention cut in a direction perpendicular to the fiber direction.

FIG. 3 is a photograph of a cross section of the meat-like food product of an embodiment of the present invention cut in a direction perpendicular to the fiber direction.

FIG. 4 is a stress-strain curve.

FIG. 5 is an explanatory diagram illustrating a method for measuring the thickness of a tightly adhered portion in a case in which one discontinuous portion is present at one place of observation when the structure is observed.

FIG. 6 is an explanatory diagram illustrating a method for measuring the thickness of a tightly adhered portion in a case in which two discontinuous portions are present at one place of observation when the structure is observed.

FIG. 7 is an explanatory diagram of a cutting method when observing the structure in the examples.

FIG. 8 is an explanatory diagram illustrating a place of observation when the structure is observed in the examples.

### DESCRIPTION OF EMBODIMENTS

Hereinafter, the present invention will be described in detail, but the present invention is not limited to the following specific embodiments.

### First Aspect: Method for Producing Meat-Like Food Product

A method for producing a meat-like food product of the present invention includes extrusion molding a kneaded product using an extruder while implementing forced cooling, the kneaded product being produced by kneading water and a raw material containing a protein.

The lower limit of the content of the protein in the raw material is preferably 45 mass %, more preferably 50 mass %, and even more preferably 60 mass % with respect to the total mass of the raw material excluding water. The upper limit of the protein content is preferably 90 mass %, more preferably 75 mass %, and even more preferably 70 mass % with respect to the total mass of the raw material excluding water.

Note that the content of protein in the raw material excluding water corresponds to the content of protein in the solid content of the kneaded product.

Also note that the content of protein in the solid content of the kneaded product also corresponds to the content of protein in the solid content of the extrusion-molded product described below.

A plant protein can be preferably used as the protein. Among the plant proteins, soybean protein, wheat protein, pea protein, rice protein, and potato protein can be particularly preferably used.

Among these, an embodiment in which soybean protein is used alone and an embodiment in which soybean protein and wheat protein are combined are preferable. A preferable embodiment of the protein blend is a blend in which the ratio of (soybean protein):(wheat protein) is from 1:2 to 1:0.

As the protein, an insect-derived protein, an algae-derived protein, a fungus-derived protein, or a cultured cell-derived protein can also be used.

Further, the raw material preferably contains starch.

The content of the starch is preferably from 5 mass % to 20 mass % with respect to the total mass of the raw materials excluding water.

The content of starch in the raw materials excluding water corresponds to the content of starch in the solid content of the kneaded product.

Also note that the content of starch in the solid content of the kneaded product also corresponds to the content of starch in the solid content of the extrusion-molded product described below.

As the starch, corn starch, potato starch and the like can be preferably used.

As the raw material, other known raw materials ordinarily used in this field can be used.

For example, carbohydrates other than starch, alkaline earth metal salts such as calcium salts and magnesium salts, dietary fibers, lipids, and the like can be appropriately used.

In the production method of the present invention, the raw materials and water are put into an extruder.

The input of water may be adjusted such that the water content of the extrusion-molded product can be adjusted to a range from 45 mass % to 60 mass %.

The lower limit of the content of water with respect to the total mass of the kneaded product of the raw materials and water is preferably 45 mass %, more preferably 50 mass %, and even more preferably 55 mass %. The upper limit of the content of water with respect to the total mass of the kneaded product of the raw materials and water is preferably 70 mass %, more preferably 65 mass %, and even more preferably 60 mass %.

An extrusion-molded product can be produced by extrusion molding a kneaded product using an extruder while forcibly cooling, the kneaded product being produced by kneading while heating.

In the production method of the present invention, the extruder that can be used for producing the meat-like food product can be used without particular limitation. The screw is preferably twin-screw. As the extruder, for example, an extruder available from Coperion GmbH can be appropriately used.

The kneading temperature in the extruder is not particularly limited as long as it is a temperature usually employed for meat-like food products, but the kneading temperature is set such that the lower limit of the maximum product temperature of the kneaded product becomes preferably 145° C., more preferably 150° C., and even more preferably 155° C. The kneading temperature is also set such that the upper limit of the maximum product temperature of the kneaded product becomes preferably 180° C., more preferably 175° C., and even more preferably 170° C.

Usually, the measured value of the product temperature at the outlet of the extruder (before the cooling die) can be regarded as the maximum product temperature of the kneaded product.

In addition, examples of the cooling die include a die in which a flow path through which a refrigerant passes is provided on an outer periphery of the die, and the refrigerant passes through the flow path to forcibly cool the kneaded product that is extruded. A meat-like food product having a good food texture can be produced by forcibly cooling the kneaded product using the cooling die to moderately expand the kneaded product when discharged from the extruder. The die preferably has a shape by which the die can mold the kneaded product into a sheet shape.

As the cooling die, for example, an apparatus available from Coperion GmbH, Bühler AG, or Clextral Inc. can be appropriately used.

The cooling die is also referred to as a cooling nozzle.

In the cooling by the cooling die, the temperature of the refrigerant and the length of the cooling die are adjusted such that the lower limit of the temperature of the central portion of the extrusion-molded product is preferably 110° C. In addition, the cooling is adjusted such that the upper limit of the central portion temperature of the extrusion-molded product is preferably 125° C.

By cooling the extrusion-molded product such that the temperature of the central portion of the extrusion-molded product falls within the above range, the extrusion-molded product is appropriately expanded when discharged from the extruder, and thereby a meat-like food product having a good food texture can be produced.

In addition, the cooling by the cooling die is carried out such that the lower limit of the water content of the extrusion-molded product is preferably 45 mass % and more preferably 50 mass % with respect to the total mass of the extrusion-molded product. In addition, the cooling is carried out such that the upper limit of the water content of the extrusion-molded product is preferably 60 mass % and more preferably 55 mass % with respect to the total mass of the extrusion-molded product.

By cooling the extrusion-molded product such that the water content of the extrusion-molded product falls within the above range, a sufficient amount of water remains in the extrusion-molded product, and a meat-like food product having a good food texture can be produced.

Heating and cooling are implemented such that a difference between the maximum temperature of the kneaded product and the temperature of the central portion of the extrusion-molded product is preferably from 30° C. to 65° C., and more preferably from 40° ° C. to 55° C.

In addition, heating and cooling are carried out such that the difference between the water content of the kneaded product and the water content of the extrusion-molded product is preferably from 2 mass % to 15 mass %, more preferably from 5 mass % to 12.5 mass %, and particularly preferably from 7.5 mass % to 10 mass %.

In the production method of the present invention, the extrusion molding is preferably carried out such that the extrusion-molded product is in the form of a sheet.

In addition, the thickness of the extrusion-molded product is preferably adjusted to a range from 6 mm to 50 mm, preferably from 10 mm to 30 mm, and more preferably from 17 mm to 20 mm. The length (lateral width) of the extrusion-molded product in a direction perpendicular to the discharge direction is not particularly limited, but may be in an approximate range from 80 mm to 100 mm as a guide.

In order to mold the extrusion-molded product into a sheet shape having a predetermined thickness and a length (lateral width) in a direction perpendicular to the discharge direction, the shape and size of the cooling die are appropriately selected, after which the temperature and water content conditions may be adjusted to the above-described preferable ranges. For example, as the cooling die, a cooling die having a quadrangular discharge port with an approximate width from 60 to 90 mm and an approximate thickness from 5 mm to 15 mm can be used. The thickness of the extrusion-molded product is preferably adjusted to around 1.5 to 3 times the thickness of the discharge port of the cooling die, and the length of the extrusion-molded product perpendicular to the discharge direction is preferably adjusted to about 1.2 to 1.5 times the width of the discharge port of the cooling die.

The thickness of the extrusion-molded product can be adjusted by providing a guide tool for correcting bulging immediately after the extrusion-molded product is discharged from the cooling die.

The sheet-shaped extrusion-molded product extruded from the die is preferably produced as a substantially rectangular extrusion-molded product by, for example, cutting the sheet-like extrusion-molded product such that the length in the direction along the discharge direction is about 50 mm to 200 mm.

In the production method of the present invention, after the extrusion-molded product is produced, if desired, the extrusion-molded product is washed, coated with a liquid such as a seasoning liquid, or immersed in a liquid such as a seasoning liquid, and then packaged to produce a product.

Preferable examples of the form of packaging include packaging with a plastic film material. In addition, boiling is a preferable example of the washing method.

Moreover, the packaged form is not particularly limited and may be in the form of retort pouch food, frozen food, or the like. However, from the viewpoint of capitalizing on the good food texture achieved by the production method of the present invention, the packaged food is preferably provided in the form of a retort pouch food. In this case, for example, the produced extrusion-molded product is sealed in a retort pouch together with a seasoning liquid and sterilized to thereby produce the packaged product.

Also note that the washing is not essential.

In addition, in order to soften the meat-like food product, a tenderizing treatment is preferably carried out. Examples of the tenderizing treatment include a perforation treatment. The tenderizing treatment can be carried out, for example, using a tenderizing tool. A liquid such as a seasoning liquid can be easily permeated into the meat-like food product by tenderizing the meat-like food product.

### Second Aspect: Meat-Like Food Product Having Specific Structure

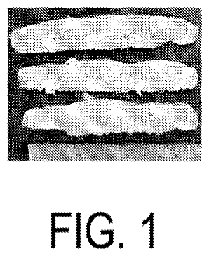

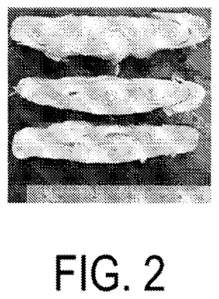

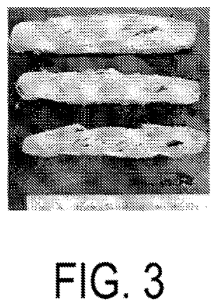

As shown in Examples described below, a meat-like food product having an oriented fibrous tissue can be produced according to the production method described in the first aspect. In addition, a discontinuous portion in which fibers are separated from each other (voids sparsely formed in the inside) can be formed inside the tissue (see FIGS. 1 to 3).

The discontinuous portion is formed through expansion during extrusion molding. Therefore, the discontinuous portion tends to have a shape extending along the fiber direction, which is the extrusion direction. However, not all of the discontinuous portions have such a shape.

In addition, a tightly adhered portion in which fibers are tightly adhered to each other is formed around the discontinuous portion. This tightly adhered portion corresponds to the continuous phase of the tissue of the entire meat-like food product.

That is, the meat-like food product of the present invention has the structural features described above, which is different from the related art, and is specified as follows.

A meat-like food product being free of meat, wherein a tissue of the meat-like food product is an oriented fibrous tissue, the tissue includes: a discontinuous portion in which fibers are separated from each other; and a tightly adhered portion in which the fibers are tightly adhered with each other, the tightly adhered portion being around the discontinuous portion, and the discontinuous portion extends along a fiber direction.

Hereinafter, the structure will be described in greater detail.

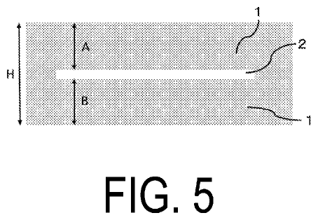

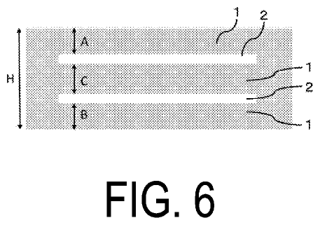

The fiber direction, the discontinuous portion and the tightly adhered portion of the meat-like food product of the present invention will be further described with reference to FIGS. 5 and 6.

FIGS. 5 and 6 schematically illustrate cross sections when the meat-like food product is cut in a direction perpendicular to the fiber direction.

In the diagrams, reference numeral 1 denotes a tightly adhered portion and reference numeral 2 denotes a discontinuous portion. Further, H represents the thickness of the meat-like food product. In addition, A, B, and C represent the thicknesses of the tightly adhered portions in the thickness direction of the meat-like food product.

The tightly adhered portion 1 is a portion of the meat-like food product that is composed of a dense fibrous tissue. The tightly adhered portion 1 refers to a portion corresponding to a so-called continuous phase in which a visually distinct discontinuous portion is not observed.

The discontinuous portion 2 is a portion of the meat-like food product in which fibers are separated from each other in the dense fibrous tissue. As can be clearly confirmed visually, this separated portion is clearly observed visually as a hole or a slit (slot).

The discontinuous portion 2 is formed inside the fibrous tissue and is not substantially observed in the appearance of the meat-like food product. Therefore, each discontinuous portion 2 is surrounded by a tightly adhered portion 1.

Such a structure can be visually observed by appropriately cutting the meat-like food product and observing the cross section thereof (see FIGS. 1 to 3).

The tightly adhered portion 1 preferably has a portion having a thickness from 3 mm to 25 mm in a direction perpendicular to the fiber direction of the meat-like food product. More preferably, the tightly adhered portion has a portion having a thickness from 5 mm to 15 mm in the direction perpendicular to the fiber direction. Even more preferably, the tightly adhered portion has a portion having a thickness from 7 mm to 10 mm in the direction perpendicular to the fiber direction.

Preferably, the meat-like food product has a structure in which a thick tightly adhered portion is formed near the surface of the meat-like food product, and a discontinuous portion is present near the center in the thickness direction of the meat-like food product. Therefore, the tightly adhered portion between the surface of the meat-like food product and the discontinuous portion includes a portion having a thickness preferably from 3 mm to 25 mm, more preferably from 5 mm to 15 mm, and even more preferably from 7 mm to 10 mm in the thickness direction.

Further, it is preferable that the meat-like food product have a structure in which the tightly adhered portion is formed between the discontinuous portions of the meat-like food product. Tightly adhered portions between voids in the meat-like food product include portions having a thickness of preferably from 3 mm to 25 mm, more preferably from 5 mm to 15 mm, and even more preferably from 7 mm to 10 mm in the thickness direction.

The lower limit of the thickness of the meat-like food product is preferably 6 mm, more preferably 15 mm, and even more preferably 20 mm.

Moreover, the upper limit of the thickness of the meat-like food product is preferably 50 mm, more preferably 40 mm, even more preferably 30 mm, particularly preferably 25 mm, and even more preferably 20 mm.

Among the tightly adhered portions observed in a cross section in a direction perpendicular to the fiber direction of the meat-like food product, tightly adhered portions having a thickness of 3 mm or greater from the surface of the meat-like food product to the discontinuous portion in a cross section preferably account for 10% or greater, more preferably 50% or greater, still more preferably 60% or greater, particularly preferably 70% or greater, and most preferably 80% or greater, of all of the tightly adhered portions.

On the other hand, tightly adhered portions having a thickness less than the 3 mm preferably account for less than 90%, more preferably less than 50%, even more preferably less than 40%, yet even more preferably less than 30%, and most preferably less than 20%, of all of the tightly adhered portions.

Here, the ratio of the thickness of the tightly adhered portion is measured by a method described below in the Examples.

That is, for a plurality of statistically significant cross sections, in each cross section, a statistically significant number of observation axes in the thickness direction are set at regular intervals, and the thickness from the surface to the discontinuous portion may be measured at each observation axis. Then, the ratio of observation points having a predetermined thickness is calculated using the total number of observation points as a parameter (the same applies hereinafter).

In addition, among the tightly adhered portions observed in a cross section in a direction perpendicular to the fiber direction of the meat-like food product, tightly adhered portions having a thickness of 5 mm or greater from the surface of the meat-like food product to the discontinuous portion in the cross section preferably account for 20% or greater, more preferably 40% or greater, still more preferably 50% or greater, and particularly preferably 60% or greater, of all of the tightly adhered portions.

In addition, it is also preferable that a tightly adhered portion having a thickness of 7 mm or greater from the surface of the meat-like food product to the discontinuous portion in the cross section is included among the tightly adhered portions observed in a cross section in a direction perpendicular to the fiber direction of the meat-like food product. Tightly adhered portions having a thickness of 7 mm or greater from the surface of the meat-like food product to the discontinuous portion in the cross section preferably account for 20% or greater, more preferably 30% or greater, and even more preferably 40% or greater, of all of the tightly adhered portions.

Moreover, among the tightly adhered portions observed in a cross section in a direction perpendicular to the fiber direction of the meat-like food product, tightly adhered portions having a thickness of 3 mm or greater between discontinuous portions in the cross section preferably account for 10% or greater, more preferably 50% or greater, and even more preferably 60% or greater, of all of the tightly adhered portions.

On the other hand, tightly adhered portions having a thickness less than 3 mm preferably account for less than 90%, more preferably less than 50%, and even more preferably less than 40% of all of the tightly adhered portions.

In addition, among the tightly adhered portions observed in a cross section in a direction perpendicular to the fiber direction of the meat-like food product, tightly adhered portions having a thickness of 5 mm or greater between discontinuous portions in the cross section preferably account for 5% or greater, more preferably 20% or greater, even more preferably 30% or greater, and particularly preferably 40% or greater, of all of the tightly adhered portions.

In addition, among the tightly adhered portions observed in a cross section in a direction perpendicular to the fiber direction of the meat-like food product, tightly adhered portions having a thickness of 7 mm or greater between discontinuous portions in the cross section preferably account for 5% or greater, more preferably 10% or greater, and even more preferably 20% or greater, of all of the tightly adhered portions.

When observed in a cross section in a direction perpendicular to the fiber direction of the meat-like food product, among the all discontinuous portions having a major axis of 0.5 mm or greater in the cross section, the proportion of discontinuous portions having a major axis of 3 mm or greater in the cross section is, on a number basis, preferably 10% or greater, more preferably 50% or greater, even more preferably 60% or greater, and particularly preferably 70% or greater.

On the other hand, on a number basis, the proportion of discontinuous portions having a major axis from 0.5 mm to less than 3 mm in the cross section is preferably 90% or less, more preferably 50% or less, even more preferably 40% or less, and particularly preferably 30% or less.

Note that observation of the cross section of the discontinuous portion is premised on observation of a statistically significant number of cross sections. In addition, the cross section to be observed does not include portions within 10 mm of the end portions (the portions at the startup and end of discharge from the extruder) of the meat-like food product.

The meat-like food product also preferably includes a discontinuous portion having a major axis of 5 mm or greater in a cross section of the meat-like food product in a direction perpendicular to the fiber direction when the meat-like food product is observed in the cross section. Moreover, when one cross section is observed, the meat-like food product preferably includes a plurality of discontinuous portions having a major axis of 5 mm or greater in the cross section.

In addition, among the discontinuous portions observed in a cross section in a direction perpendicular to the fiber direction of the meat-like food product, the meat-like food product preferably includes a discontinuous portion having a major axis of 5 mm or greater in the cross section.

In addition, discontinuous portions having a major axis of 5 mm or greater in a cross section in a direction perpendicular to the fiber direction of the meat-like food product account for, on a number basis, preferably 10% or greater, more preferably 15% or greater, and even more preferably 20% or greater of the discontinuous portions observed in the cross section.

The meat-like food product also preferably includes a discontinuous portion having a major axis of 7.5 mm or greater in a cross section of the meat-like food product in a direction perpendicular to the fiber direction when the meat-like food product is observed in the cross section.

On a number basis, the discontinuous portions having a major axis of 7.5 mm or greater in a cross section in a direction perpendicular to the fiber direction of the meat-like food product preferably account for 5% or greater, more preferably 7% or greater, and even more preferably 15% or greater of the discontinuous portions observed in the cross section.

In addition, when observed in a cross section in a direction perpendicular to the fiber direction of the meat-like food product, the meat-like food product preferably includes a discontinuous portion having a major axis of 7.5 mm or greater in the cross section, and it is also preferable that the meat-like food includes a discontinuous portion having a major axis of 10 mm or greater and a discontinuous portion having a major axis of 15 mm or greater in the cross section.

In addition, a preferable aspect of the meat-like food product is one that includes a discontinuous portion having a major axis of preferably 5 mm or greater, more preferably 7.5 mm or greater, and even more preferably 10 mm or greater.

The major axis referred to here is the major axis of the discontinuous portion contained in the meat-like food product, and therefore is usually the diameter in the direction along the fiber direction. This diameter can be measured by observing a cross section along the fiber direction.

Further, an aspect containing a plurality of discontinuous portions is preferable.

It should be noted that the above descriptions of the thickness of the tightly adhered portion and the major axis of the discontinuous portion are not intended to exclude, from the present invention, those meat-like food products including a discontinuous portion and a tightly adhered portion having sizes outside the above ranges.

Further, the discontinuous portion may be a void or may contain an arbitrary component.

The form of the discontinuous portion is not particularly limited, and the discontinuous portion may be formed by expansion through extrusion molding, or may be formed by making a cut in the tissue from the side with a knife-like instrument. In addition, the discontinuous portion may be formed by laminating two or more protein sheets and partially adhering the surfaces of the sheets to each other.

As the protein sheet, a high-water content type meat-like food product containing protein and being free of meat and which is produced by an ordinary method can be used.

As the adhesive, transglutaminase, modified starch, methylated cellulose, pyrophosphoric acid, soybean separated protein, wheat gluten, curdlan, and a gelling agent can be preferably used.

Further, the meat-like food product of the present invention is preferably extrusion-molded by an extruder, and the meat-like food product of the present invention is particularly preferably produced by the production method of the first aspect described above.

Further, the meat-like food product of the present invention preferably has pores formed by a tenderizing treatment. Examples of the tenderizing treatment include a perforation treatment. The tenderizing treatment can be carried out, for example, using a tenderizing tool. A liquid such as a seasoning liquid can be easily permeated into the meat-like food product by tenderizing the meat-like food product.

The meat-like food product of the present invention having the structural features described above exhibits an excellent food texture like that of chicken. In addition, the presence of the discontinuous portion provides an additional effect of facilitating the permeation of a seasoning liquid.

### Third Aspect: Meat-Like Food Product Having Specific Physical Properties

With regard to the meat-like food product produced by the production method of the first aspect, the present inventors elucidated the physical properties required for realizing a good food texture like that of chicken.

That is, in the meat-like food product of the present invention, an average value obtained by measuring two or more different points by the following method using a Tensipresser satisfies at least one of the following (A) to (D).

In the present specification, the term “Tensipresser” refers to a product name of the Tensipresser My Boy II System available from Taketomo Electric Inc. The Tensipresser applies a force to a sample while vibrating a plunger up and down to deform the sample little by little to measure parameters, and the principle thereof is described in JP 2005-84044 A.
(A) A breaking stress (tenderness) is from 10000 gw/cm² to 47000 gw/cm², preferably from 15000 gw/cm² to 30000 gw/cm², more preferably from 18000 gw/cm² to 25000 gw/cm², even more preferably from 20000 gw/cm² to 24000 gw/cm², and particularly preferably from 22000 gw/cm² to 23000 gw/cm².
(B) A total workload (toughness) is from 5000 gw/cm² to 15300 gw/cm², preferably from 8000 gw/cm² to 14000 gw/cm², more preferably from 10000 gw/cm² to 13000 gw/cm², and even more preferably from 11000 gw/cm² to 12000 gw/cm².
(C) A pliability is from 0.5 to 2.1, preferably from 0.9 to 2.1, more preferably from 1.0 to 1.5, and even more preferably from 1.1 to 1.3.
(D) A brittleness is from 1.3 to 3.5, preferably from 1.4 to 3.0, more preferably from 1.6 to 2.5, and even more preferably from 1.8 to 2.0.

The meat-like food product of the present invention preferably satisfies the above-mentioned ranges of preferably two or more, more preferably three or more, and even more preferably all of the physical properties (A) to (D).

The method of measurement using the Tensipresser will be described below.

Measurements are carried out by the following method using the Tensipresser (product name: Tensipresser My Boy II System) available from Taketomo Electric Inc.

The sample to be measured is prepared such that the thickness in the direction perpendicular to the fiber direction is 15 mm.

The measurements are carried out by a multiple integration bite method using a cylindrical plunger with a diameter of 5 mm.

The measurement temperature is set to 20° C. Note that when the measurement temperature is low, the breaking stress and the total workload tend to increase, and when the measurement temperature is high, the breaking stress and the total workload tend to decrease.

The other conditions include a bite speed of 2.00 mm/sec, a second speed of 2.00 mm/sec, a plansure area of 0.041 cm², and an add value of 0.100 mm.

The breaking stress (tenderness), the total workload (toughness), the pliability, and the brittleness can be measured by applying a force to a sample using the Tensipresser while vibrating a plunger up and down to deform the sample little by little, and measuring values until breaking occurs.

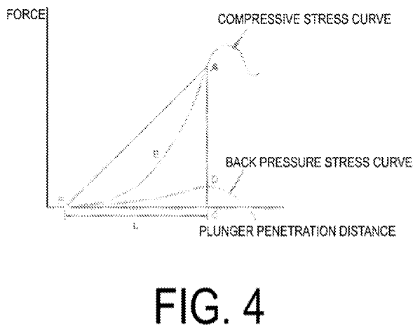

The breaking stress (tenderness) is the compressive stress at a point A on a compressive stress curve when the plunger penetrates into the sample and the sample breaks (maximum value point D of the back pressure stress curve in FIG. 4). The breaking stress represents softness, and a larger breaking stress value indicates a harder meat-like food product.

The total workload (toughness) is the workload until breakage occurs, and is represented by the area of the curved surface AEBC in FIG. 4. A larger total workload value indicates a more chewy meat-like food product.

The pliability is represented by an area ratio (AABC/the curved surface AEBC) in FIG. 4. The pliability represents flexibility, and as the pliability value increases, the harder it is to bite off a piece of the meat-like food product.

The brittleness is represented by (sample thickness)/(plunger penetration distance (L in FIG. 4)). A large brittleness value indicates a more brittle meat-like food product. The measurements are carried out at two or more points, and an average value is calculated. The number of measurement points is only required to be a statistically significant number. The number of measurement points is preferably 3 or more, and more preferably 5 or more.

When the amount of water in the kneaded product is reduced, the kneaded product becomes sponge-like, the breaking stress (tenderness) and pliability tend to increase, and the brittleness tends to decrease.

The meat-like food products of the second and third aspects preferably have a water content of 50 mass % or greater, more preferably 55 mass % or greater, and even more preferably 60 mass % or greater. Moreover, as a guideline, the upper limit of the water content is 80 mass %, preferably 75 mass %, and more preferably 70 mass %.

If desired, the meat-like food product of the present invention may be coated with a liquid such as a seasoning liquid or immersed in a liquid such as a seasoning liquid, and then preferably packaged in a plastic film material and subjected to retort sterilization to produce a meat-like food product in a retort pouch.

Note that by removing the excess amount of water retained in the tissue, the retort-treated meat-like food product can be regarded as containing the same amount of water as the amount of water contained in the extrusion-molded product. An example of a method for removing the excess amount of water retained in the tissue is a method in which the tissue is ground to around 5 mm, and a pressure is applied to push out the water.

### Fourth Aspect: Method for Producing Meat-Like Food Product (Improved Flavor)

The present invention is a method for producing a meat-like food product that is free of meat, the method including:
extrusion molding a kneaded product using an extruder to thereby produce an extrusion-molded product, the kneaded product being produced by kneading water and a raw material containing a protein while heating.

The present invention is characterized in that an extrusion-molded product produced using an extruder is used as the raw material to be fed into the extruder.

That is, an extrusion-molded product produced by extrusion molding a protein as a raw material with an extruder is fed into the extruder once again to produce an extrusion-molded product.

The extrusion-molded product serving as a raw material is not particularly limited, and a commercially available meat-like food product may be used, or a product produced by an extruder using a protein according to a known technique may be used.

As the extrusion-molded product to be used as the raw material, one having a low water content can be preferably used. The water content in the extrusion-molded product is preferably 25 mass % or less, more preferably 20 mass % or less, and even more preferably 15 mass % or less.

In the extrusion molding of the present invention, an extrusion-molded product is produced by putting, as raw materials, an extrusion-molded product and water into an extruder, kneading the raw materials while heating the raw materials, and extruding the resulting kneaded product.

In the production method of the present invention, the extruder that can be used for producing the meat-like food product can be used without particular limitation. The screw is preferably a twin-screw. As the extruder, for example, an extruder available from Bühler AG, Coperion GmbH, or Kowa Kogyo Inc. can be appropriately used.

The extruder process may be a high-water content extruder process (to form a dense fibrous structure) or a low-water content extruder process (to form a sponge-like structure).

That is, by adjusting the water added to the raw material, the heating temperature, and the degree of cooling, the water content and the tissue structure of the extrusion-molded product can be changed, and in the present invention, the water content and tissue structure can be selected.

In the present invention, the extrusion molding is preferably carried out one or more times. Here, the raw material in the extrusion molding subsequent to the first extrusion molding is the extrusion-molded product resulting from the previous extrusion molding. That is, the flavor can be further improved by carrying out the extrusion molding process with the extruder two or more times until a final extrusion-molded product that serves as the final product is produced.

The conditions of the final extrusion molding can be set in accordance with the desired form of the final extrusion-molded product. For example, the final extrusion-molded product preferably takes on a form like that described in the first aspect.

An extrusion-molded product produced in an intermediate (not final) extrusion molding may be produced in any form, and is preferably produced as a low-water content type extrusion-molded product. More specifically, an intermediate extrusion-molded product is preferably one having a water content of 45 mass % or less. In addition, the intermediate extrusion-molded product is preferably an extrusion-molded product produced through an extruder process in which the maximum product temperature of the kneaded product is 130° C. or higher.

It is also preferable that, before the extrusion molding, the raw material (the extrusion-molded product produced in the previous extrusion molding) be washed and dehydrated. By carrying out a washing and dehydration treatment, the flavor of the protein raw material such as soybeans can be reduced.

In addition, after dehydration, drying may or may not be performed. Water may be contained as long as the water content is in a range that can be adjusted to a preferable range through blending in the subsequent extrusion molding.

As a specific embodiment, preferably, the low-water content extruder process (process for producing a sponge-like structure) is carried out from one to three times, after which the process described in the first aspect is lastly carried out.

In addition, any embodiment of the method for producing a meat-like food product using an ordinary extruder can be appropriately selected. Moreover, a meat-like food product can be produced in accordance with a preferred embodiment like that described in the first aspect.

### EXAMPLES

### Manufacturing Method

### Example 1

Raw materials containing 65 mass % of protein and 10 mass % of starch (with the remainder being a carbohydrate other than starch, calcium salt, and lipids) and water were put into an extruder, kneaded while being heated and pressurized, and extruded from a cooling die to produce a meat-like food product. As the protein, a protein derived from soybeans and a protein derived from wheat were prepared at a mass ratio of 1:1. The water content in the extrusion-molded product and the core temperature in the extrusion-molded product were as described in Table 1.

The water content in the kneaded product was adjusted to within a range from 35 mass % to 80 mass %. Moreover, the maximum product temperature of the kneaded product was adjusted to within a range from 145° C. to 180° C.

Note that when the water content in the kneaded product is increased, the water content in the extrusion-molded product also increases. Further, when the maximum product temperature of the kneaded product is increased, the center temperature of the extrusion-molded product also increases. In addition, when the maximum product temperature of the kneaded product is increased, the water content in the extrusion-molded product with respect to the water content in the kneaded product is reduced.

Thus, in the present example, heating and cooling were implemented such that the difference between the water content in the kneaded product and the water content of the extrusion-molded product was from 5 to 10 mass %, and the difference between the maximum product temperature in the kneaded product and the product temperature at the central portion of the extrusion-molded product was from 30 to 65° C.

As the extruder, a twin-screw extruder (available from Coperion GmbH) was used.

Moreover, as the cooling die, an apparatus capable of molding the kneaded product into a sheet shape and having an outlet size measuring 75 mm wide and 10 mm thick was used.

The extrusion-molded product measured from 75 to 100 mm (length in a direction perpendicular to the discharge direction, that is, the fiber direction) by from 10 to 20 mm (thickness), and was cut such that the length in a direction along the discharge direction and the fiber direction was about 60 mm, and thereby one sheet of the extrusion-molded product was produced.

One sheet of the resulting extrusion-molded product was subjected to retort sterilization with the addition of 200 mL of water, and a retort pouched meat-like food product was produced. Subsequently, the retort pouched meat-like food product was cooled to room temperature (25° C.), after which the retort pouch was opened, and the meat-like food product was removed.

The food texture of the meat-like food product was evaluated by one expert panelist. The food texture of each of the meat-like food products was evaluated as when the food texture was excellent, Δ when the food texture was of a normal level, or x when the food texture was poor or a sheet shape was not formed. The results are shown in Table 1 (a blank cell in the table indicates that the evaluation was not performed).

The meat-like food product in which the water content of the extrusion-molded product was from 45 mass % to 60 mass % and the temperature of the central portion in the extrusion-molded product was from 110° C. to 125° ° C. exhibited a good food texture like that of chicken.

TABLE 1

| Water Content (%) in | Temperature of Central Portion | | | | | | | |
|---|---|---|---|---|---|---|---|---|
| Extrusion-Molded Product | 100° C. | 105° C. | 110° C. | 115° C. | 120° C. | 125° C. | 130° C. | 135° C. |
| 35% | | | x | x | x | x | | |
| 40% | | x | Δ | Δ | Δ | Δ | x | |
| 45% | x | Δ | ○ | ○ | ○ | ○ | Δ | x |
| 50% | x | Δ | ○ | ○ | ○ | ○ | Δ | x |
| 60% | x | Δ | ○ | ○ | ○ | ○ | Δ | x |
| 65% | | x | Δ | Δ | Δ | Δ | x | |
| 70% | | | x | x | x | x | | |

### Example 2

Raw materials containing protein and starch, and water were put into an extruder, and in the same manner as in Example 1, the raw materials and water were kneaded while being heated and pressurized, and extruded from a cooling die to produce a meat-like food product. As the protein, a protein derived from soybeans and a protein derived from wheat were prepared at a mass ratio of 1:1. The content percentages of the protein and starch in the solid content were as indicated in Table 2.

Carbohydrates other than starch, lipids and trace amounts of calcium salt were used as other components in the raw material.

The water content in the kneaded product was adjusted within a range from 45 mass % to 70 mass %. Moreover, the maximum product temperature of the kneaded product was adjusted to within a range from 145° ° C. to 180° C.

Thus, in the present example, heating and cooling were implemented such that the difference between the water content in the kneaded product and the water content of the extrusion-molded product was from 5 mass % to 10 mass %, and the difference between the maximum product temperature in the kneaded product and the product temperature at the central portion of the extrusion-molded product was from 30° ° C. to 65° C.

Meat-like food products differing in the water content of the extrusion-molded product, the temperature of the central portion of the extrusion-molded product, and the content amounts of protein and starch in the raw material were produced and evaluated in the same manner as in Example 1. The results are shown in Table 2.

All the meat-like food products produced in Example 2 exhibited a good food texture like that of chicken.

TABLE 2

| | | Water Content | | | | |
|---|---|---|---|---|---|---|
| Content (%) in Solid Content | | (%) of Extrusion- | Temperature of Central Portion | | | |
| Protein | Starch | Molded Product | 110° C. | 115° C. | 120° C. | 125° C. |
| 65% | 10% | 45% | ○ | ○ | ○ | ○ |
| | | 50% | ○ | ○ | ○ | ○ |
| | | 60% | ○ | ○ | ○ | ○ |
| 75% | 5% | 45% | ○ | ○ | ○ | ○ |
| | | 60% | ○ | ○ | ○ | ○ |
| 70% | 5% | 45% | ○ | ○ | ○ | ○ |
| | | 60% | ○ | ○ | ○ | ○ |
| 65% | 5% | 45% | ○ | ○ | ○ | ○ |
| | | 60% | ○ | ○ | ○ | ○ |
| 60% | 5% | 45% | ○ | ○ | ○ | ○ |
| | | 60% | ○ | ○ | ○ | ○ |
| 50% | 5% | 45% | ○ | ○ | ○ | ○ |
| | | 60% | ○ | ○ | ○ | ○ |
| 70% | 15% | 45% | ○ | ○ | ○ | ○ |
| | | 60% | ○ | ○ | ○ | ○ |
| 65% | 15% | 45% | ○ | ○ | ○ | ○ |
| | | 60% | ○ | ○ | ○ | ○ |
| 60% | 15% | 45% | ○ | ○ | ○ | ○ |
| | | 60% | ○ | ○ | ○ | ○ |
| 50% | 15% | 45% | ○ | ○ | ○ | ○ |
| | | 60% | ○ | ○ | ○ | ○ |

### Example 3

In the same manner as in Example 1, raw materials containing protein and starch, and water were put into an extruder, kneaded under heating and pressure, and extruded from a cooling die to produce a meat-like food product. As the protein, a protein derived from soybeans and a protein derived from wheat were used. The content percentages of the protein and starch in the raw materials were as indicated in Table 3.

Carbohydrates other than starch, lipids and trace amounts of calcium salt were used as other components in the raw material.

The water content in the kneaded product was adjusted within a range from 45 mass % to 70 mass %. Moreover, the maximum product temperature of the kneaded product was adjusted to within a range from 145° C. to 180° C.

Thus, in the present example, heating and cooling were implemented such that the difference between the water content in the kneaded product and the water content of the extrusion-molded product was from 5 to 10 mass %, and the difference between the maximum product temperature in the kneaded product and the product temperature at the central portion of the extrusion-molded product was from 30 to 65° C.

Meat-like food products differing in the water content of the extrusion-molded product, the temperature of the central portion of the extrusion-molded product, the content amounts of protein and starch in the raw material, and the protein raw material were produced and evaluated in the same manner as in Example 1. The results are shown in Table 3.

All the meat-like food products produced in Example 3 exhibited a good food texture like that of chicken.

TABLE 3

| | | Water Content | | | | |
|---|---|---|---|---|---|---|
| | | (%) of | | | | |
| Content Percentage in Solid | | Extrusion- | | | | |
| Content | | Molded | Temperature of Central Portion | | | |
| Protein | Starch | Product | 110° C. | 115° C. | 120° C. | 125° C. |
| 65% | 10% | 45% | ○ | ○ | ○ | ○ |
| (soybean:wheat = 1:2) | | 50% | ○ | ○ | ○ | ○ |
| | | 60% | ○ | ○ | ○ | ○ |
| 65% | 10% | 45% | ○ | ○ | ○ | ○ |
| (soybean:wheat = 1:1) | | 60% | ○ | ○ | ○ | ○ |
| 65% | 10% | 45% | ○ | ○ | ○ | ○ |
| (soybean:wheat = 2:1) | | 60% | ○ | ○ | ○ | ○ |
| 65% | 10% | 45% | ○ | ○ | ○ | ○ |
| (soybean:wheat = 3:1) | | 60% | ○ | ○ | ○ | ○ |
| 65% | 10% | 45% | ○ | ○ | ○ | ○ |
| (soybean:wheat = 5:1) | | 60% | ○ | ○ | ○ | ○ |
| 65% | 10% | 45% | ○ | ○ | ○ | ○ |
| (soybean only) | | 60% | ○ | ○ | ○ | ○ |
| 75% | 5% | 45% | ○ | ○ | ○ | ○ |
| (soybean:wheat = 1:1) | | 60% | ○ | ○ | ○ | ○ |
| 75% | 5% | 45% | ○ | ○ | ○ | ○ |
| (soybean:wheat = 2:1) | | 60% | ○ | ○ | ○ | ○ |
| 75% | 5% | 45% | ○ | ○ | ○ | ○ |
| (soybean only) | | 60% | ○ | ○ | ○ | ○ |
| 50% | 5% | 45% | ○ | ○ | ○ | ○ |
| (soybean:wheat = 1:1) | | 60% | ○ | ○ | ○ | ○ |
| 50% | 5% | 45% | ○ | ○ | ○ | ○ |
| (soybean:wheat = 2:1) | | 60% | ○ | ○ | ○ | ○ |
| 50% | 5% | 45% | ○ | ○ | ○ | ○ |
| (Soybean only) | | 60% | ○ | ○ | ○ | ○ |
| 70% | 15% | 45% | ○ | ○ | ○ | ○ |
| (soybean:wheat = 1:1) | | 60% | ○ | ○ | ○ | ○ |
| 70% | 15% | 45% | ○ | ○ | ○ | ○ |
| (soybean:wheat = 2:1) | | 60% | ○ | ○ | ○ | ○ |
| 70% | 15% | 45% | ○ | ○ | ○ | ○ |
| (Soybean only) | | 60% | ○ | ○ | ○ | ○ |
| 50% | 15% | 45% | ○ | ○ | ○ | ○ |
| (soybean:wheat = 1:1) | | 60% | ○ | ○ | ○ | ○ |
| 50% | 15% | 45% | ○ | ○ | ○ | ○ |
| (soybean:wheat = 2:1) | | 60% | ○ | ○ | ○ | ○ |
| 50% | 15% | 45% | ○ | ○ | ○ | ○ |
| (soybean only) | | 60% | ○ | ○ | ○ | ○ |

### Evaluation of Structure and Food Texture of Meat-Like Food Product

### Example 4

The relationship between the structure and food texture of the meat-like food products of the twelve samples (No. 1 to No. 12) produced in Example 1 was evaluated.

As comparative examples, the following samples were also prepared.

The extrusion-molded product was in the form of a sheet having a width (length in the direction perpendicular to the discharge direction) from 80 to 95 mm and a thickness of approximately 17 to 20 mm. The length (length in the direction along the discharge direction) was cut to approximately 60 mm.

### Comparative Example 1

A meat-like food product having a water content of the extrusion-molded product of approximately 15 mass % was produced in the same manner as in the preparation of Example 1 with the exception that only the water content in the kneaded product was changed to 30 mass %, a die without a forced cooling function was used, and the kneaded product was expanded without cooling at the time of discharge.

The extrusion-molded product was in the form of a rod having a width (length in a direction perpendicular to the discharge direction) from 30 to 40 mm and an approximate thickness from 10 to 15 mm.

### Comparative Example 2

A meat-like food product was produced in the same manner as in the preparation of Example 1 with the exception that the cooling die was adjusted such that the temperature of the central portion of the extrusion-molded product was 80° C. The water content of the extrusion-molded product was somewhat higher than in the Examples.

The extrusion-molded product had a width (length in the directly perpendicular to the discharge direction) of 80 mm and a thickness of approximately 13 mm. The length (length in the direction along the discharge direction) was cut to approximately 60 mm.

The resulting extrusion-molded product was subjected to retort sterilization with the addition of water, and a retort pouched meat-like food product was produced. Subsequently, the retort pouched meat-like food product was cooled to room temperature, after which the retort pouch was opened, and the meat-like food product was removed.

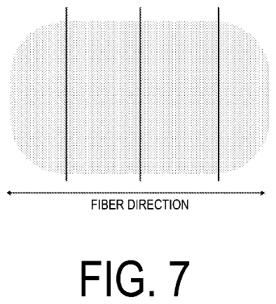

The meat-like food product was cut in a direction perpendicular to the fiber direction at positions indicated by the solid lines in FIG. 7 to thereby prepare samples having a width of approximately 4 mm, and the state of voids formed in the cross section was observed.

In addition, the major axis in a cross section of a void observable in a cross section in a direction perpendicular to the fiber direction, the thickness of the tightly adhered portion from the surface of the meat-like food product to the void (distance along the thickness direction, A and B in FIGS. 5 and 6), and the thickness of the tightly adhered portion between voids (distance along the thickness direction, C in FIG. 6) were measured from a photographed image of the meat-like food product.

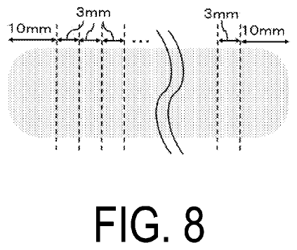

In the measurements of the Examples and Comparative Examples, with regard to any three cross sections of each sample, observation axes were provided every 3 mm in locations excluding 10 mm at both ends of the formed cross section, as shown by the dotted lines in FIG. 8, and each item was measured along the observation axes.

The results are shown in Table 4.

The meat-like food products of the twelve samples (No. 1 to No. 12) produced in Example 1 all exhibited excellent food texture (evaluation: ◯).

On the other hand, the meat-like food product of Comparative Example 1 did not exhibit chewiness and had a sponge-like food texture (evaluation: x).

The meat-like food product of Comparative Example 2 exhibited chewiness but was inferior in softness and a sense of crumbling (evaluation: Δ).

TABLE 4

| | | Central | | | | | | | | | | | | |
|---|---|---|---|---|---|---|---|---|---|---|---|---|---|---|
| | | Portion | | | | | | | | | | | | |
| | Water | Temper- | | | | | | | | | | | | |
| | Content | ature | Maxi- | | | | | | | | | | | |
| | (%) in | (° C.) of | mum | | | | | | | | | | | |
| | Extrusion- | Extrusion- | Thick- | Lateral | | | | | | | | | | |
| Sample | Molded | Molded | ness | Length | | | | | | | | | | |
| No. | Product | Product | (mm) | (mm) | Structural Features | | | | | | | | | |
| 1 | 45 | 110 | 18 | 98 | Voids extend in fiber direction. | | | | | | | | | |
| | | | | | Voids are thin slit-shaped and are few. | | | | | | | | | |
| | | | | | Tightly adhered portion has thick, uniform structure. | | | | | | | | | |
| 2 | 45 | 115 | 22 | 111 | Voids extend in fiber direction. | | | | | | | | | |
| | | | | | Voids are thin slit-shaped. | | | | | | | | | |
| 3 | 45 | 120 | 18 | 102 | Voids extend in fiber direction. | | | | | | | | | |
| | | | | | Thin slit-shaped voids are present throughout. | | | | | | | | | |
| 4 | 45 | 125 | 22 | 110 | Voids extend in fiber direction. | | | | | | | | | |
| | | | | | Many of the voids are small and are concentrated at central | | | | | | | | | |
| | | | | | portion. | | | | | | | | | |
| 5 | 50 | 110 | 23 | 118 | Voids extend in fiber direction. | | | | | | | | | |
| | | | | | A mixture of thin slit-shaped voids and small voids is | | | | | | | | | |
| | | | | | present. | | | | | | | | | |
| 6 | 50 | 115 | 26 | 115 | Voids extend in fiber direction. | | | | | | | | | |
| | | | | | A mixture of small voids and large voids is present in central | | | | | | | | | |
| | | | | | portion. | | | | | | | | | |
| 7 | 50 | 120 | 21 | 111 | Voids extend in the fiber direction. | | | | | | | | | |
| | | | | | A large number of large voids are present in middle part. | | | | | | | | | |
| 8 | 50 | 125 | 23 | 102 | Voids extend in the fiber direction. | | | | | | | | | |
| | | | | | A large number of large voids are present in middle part. | | | | | | | | | |
| 9 | 60 | 110 | 23 | 96 | Voids extend in the fiber direction. | | | | | | | | | |
| | | | | | A large number of large voids are present in middle part. | | | | | | | | | |
| 10 | 60 | 115 | 25 | 99 | Voids extend in the fiber direction. | | | | | | | | | |
| | | | | | A large number of large voids are present in middle part. | | | | | | | | | |
| 11 | 60 | 120 | 23 | 93 | Voids extend in the fiber direction. | | | | | | | | | |
| | | | | | A large number of large voids are present in middle part. | | | | | | | | | |
| 12 | 60 | 125 | 26 | 102 | Voids extend in the fiber direction. | | | | | | | | | |
| | | | | | A large number of large voids are present in middle part. | | | | | | | | | |
| Compar- | 30 | 140 | 20 | 57 | Randomly a large number of small voids are present. | | | | | | | | | |
| ative | | | | | | | | | | | | | | |
| Example | | | | | | | | | | | | | | |
| 1 | | | | | | | | | | | | | | |
| Compar- | 50 | 80 | 13 | 80 | No voids | | | | | | | | | |
| ative | | | | | | | | | | | | | | |
| Example | | | | | | | | | | | | | | |
| 2 | | | | | | | | | | | | | | |
| | Distance from Surface to Void | | | | Distance Between Voids | | | | | | | | | |
| | (Thicknesses A and B of Tightly | | | | (Thickness C of Tightly | | | | Major Axis (mm) in Cross Section of | | | | | |
| | Adhered Portion) | | | | Adhered Portion) | | | | Void | | | | | |
| | | 3 mm | 5 mm | 7 mm | Less | 3 mm | 5 mm | 7 mm | From 0.5 | 3 mm | 5 mm | 7.5 | 10 | |
| | Less | or | or | or | than | or | or | or | mm to less | or | or | mm or | mm or | Eating |
| Sample | than 3 | greater | greater | greater | 3 mm | greater | greater | greater | than 3 mm | greater | greater | greater | greater | Evalu- |
| No. | mm (%) | (%) | (%) | (%) | (%) | (%) | (%) | (%) | (%) | (%) | (%) | (%) | (%) | ation |
| 1 | 21 | 79 | 51 | 28 | 29 | 70 | 41 | 18 | 41 | 59 | 31 | 15 | 8 | ○ |
| 2 | 13 | 87 | 67 | 32 | 50 | 50 | 7 | 0 | 33 | 66 | 42 | 24 | 12 | ○ |
| 3 | 14 | 86 | 62 | 34 | 36 | 64 | 29 | 4 | 39 | 61 | 31 | 13 | 6 | ○ |
| 4 | 7 | 93 | 84 | 39 | 32 | 68 | 20 | 3 | 51 | 49 | 15 | 5 | 1 | ○ |
| 5 | 10 | 90 | 67 | 33 | 11 | 89 | 53 | 23 | 50 | 51 | 24 | 16 | 10 | ○ |
| 6 | 14 | 86 | 56 | 23 | 24 | 75 | 46 | 16 | 53 | 48 | 21 | 12 | 7 | ○ |
| 7 | 17 | 83 | 57 | 30 | 17 | 82 | 64 | 15 | 35 | 65 | 32 | 21 | 12 | ○ |
| 8 | 11 | 89 | 63 | 30 | 28 | 73 | 28 | 11 | 21 | 79 | 39 | 19 | 8 | ○ |
| 9 | 15 | 85 | 70 | 40 | 28 | 72 | 30 | 11 | 42 | 58 | 25 | 15 | 5 | ○ |
| 10 | 9 | 91 | 78 | 48 | 36 | 63 | 25 | 9 | 46 | 53 | 21 | 9 | 3 | ○ |
| 11 | 27 | 73 | 43 | 28 | 31 | 69 | 49 | 29 | 48 | 53 | 29 | 16 | 9 | ○ |
| 12 | 25 | 75 | 43 | 27 | 26 | 73 | 45 | 24 | 36 | 65 | 36 | 20 | 9 | ○ |
| Compar- | 1 | 0 | 0 | 0 | 1 | 0 | 0 | 0 | 97.7 | 2.3 | 0.3 | 0 | 0 | x |
| ative | | | | | | | | | | | | | | |
| Example | | | | | | | | | | | | | | |
| 1 | | | | | | | | | | | | | | |
| Compar- | — | — | — | — | — | — | — | — | — | — | — | — | — | Δ |
| ative | | | | | | | | | | | | | | |
| Example | | | | | | | | | | | | | | |
| 2 | | | | | | | | | | | | | | |

### Example 5

A knife was inserted into the side of the meat-like food product of Comparative Example 2 in Example 4 from the side of the meat-like food product to make a cut internally and thereby form a void, and the food texture was evaluated.

As a result, compared to Comparative Example 2, softness and a sense of crumbling were imparted (evaluation: ◯). However, the food texture was somewhat inferior to that of the meat-like food products of the Examples (Nos. 1 to 12).

### Example 6

In the same manner as in Comparative Example 2, the shape of the die was adjusted to prepare plant protein sheets having a thickness of approximately 3 mm. The prepared sheets were boiled, after which five sheets were overlapped and adhered to each other with transglutaminase to form voids, and the sheets were pressure bonded using a vacuum pack, followed by retort cooking, and the meat-like food product was removed and evaluated.

As a result, compared to Comparative Example 2, softness and a sense of crumbling were imparted (evaluation: ◯). However, the food texture was somewhat inferior to that of the meat-like food products of the Examples (Nos. 1 to 12).

### Evaluation of Physical Properties of Meat-Like Food Product

### Example 7

The relationship between the physical properties and food texture of the meat-like food products of the twelve samples (No. 1 to No. 12) produced in Example 1 was evaluated.

Also, as a comparative example, a block type of ZEN MEAT was also evaluated.

The retorted meat-like food product was returned to room temperature, the moisture on the surface was lightly removed, the meat-like food product was adjusted to a dimension from 10 mm to 25 mm in the thickness direction to prepare a sample, and the physical properties of the sample were evaluated.

The Comparative Example was similarly retort processed and used.

Using a Tensipresser (Tensipresser My Boy II System available from Taketomo Electric Inc.), a force was applied to the sample from the thickness direction (direction perpendicular to the fiber direction) while vibrating a plunger up and down to deform the sample little by little, and from measurement values obtained until breaking occurred, the breaking stress (tenderness), total workload (toughness), pliability, and brittleness were measured. The measurement method was in accordance with a method stipulated by the National Livestock Breeding Center. Two or more points were measured for each sample, and the average values are shown in Table 5.

The measurement conditions were as follows.
Sample thickness: 10 mm to 25 mm in a direction perpendicular to the fiber direction
Plunger: cylindrical with diameter of 5 mm
Bite Speed: 2.00 mm/sec
Second Speed: 2.00 mm/sec
Plansure Area: 0.041 cm²
Add Value: 0.100 mm
Temperature: 20° C.±5° ° C.
Measurement method: multiple integration bite method.

The breaking stress (tenderness), the total workload (toughness), the pliability, and the brittleness can be measured by applying a force to a sample using the Tensipresser while vibrating a plunger up and down to deform the sample little by little, and measuring values until breaking occurs.

The breaking stress (tenderness) is the compressive stress at a point A on a compressive stress curve when the plunger penetrates into the sample and the sample breaks (maximum value point D of the back pressure stress curve in FIG. 4). The breaking stress represents softness, and a larger breaking stress value indicates a harder meat-like food product.

The total workload (toughness) is the workload until breakage occurs, and is represented by the area of the curved surface AEBC in FIG. 4. A larger total workload value indicates a more chewy meat-like food product.

The pliability is represented by an area ratio (AABC/the curved surface AEBC) in FIG. 4. The pliability represents flexibility, and as the pliability value increases, the harder it is to bite off a piece of the meat-like food product.

The brittleness is represented by (sample thickness)/(plunger penetration distance (L in FIG. 4)). A large brittleness value indicates a more brittle meat-like food product.

TABLE 5

| | Water Content | | | Total | | | | |
|---|---|---|---|---|---|---|---|---|
| | (%) in | Temperature | Breaking | Workload | | | Thickness | |
| | Extrusion- | (° C.) of | Stress | (Toughness) | | | (Sample | |
| | Molded | Central | (Tenderness) | (gw · cm/ | | | Thickness) | Eating |
| No. | Product | Portion | (gw/cm²) | cm²) | Pliability | Brittleness | (mm) | Evaluation |
| 1 | 45 | 110 | 1.89E+04 | 5.74E+03 | 1.06E+00 | 2.75E+00 | 1.60E+01 | ○ |
| 2 | 45 | 115 | 2.23E+04 | 8.70E+03 | 1.07E+00 | 2.11E+00 | 1.73E+01 | ○ |
| 3 | 45 | 120 | 2.37E+04 | 8.03E+03 | 1.09E+00 | 1.99E+00 | 1.45E+01 | ○ |
| 4 | 45 | 125 | 2.32E+04 | 1.10E+04 | 9.19E−01 | 2.23E+00 | 1.78E+01 | ○ |
| 5 | 50 | 110 | 2.22E+04 | 1.41E+04 | 9.75E−01 | 1.80E+00 | 2.12E+01 | ○ |
| 6 | 50 | 115 | 2.34E+04 | 1.14E+04 | 1.08E+00 | 1.97E+00 | 2.04E+01 | ○ |
| 7 | 50 | 120 | 2.88E+04 | 1.18E+04 | 1.07E+00 | 2.05E+00 | 1.72E+01 | ○ |
| 8 | 50 | 125 | 2.29E+04 | 1.11E+04 | 1.19E+00 | 1.89E+00 | 2.11E+01 | ○ |
| 9 | 60 | 110 | 2.62E+04 | 1.14E+04 | 1.11E+00 | 2.04E+00 | 1.94E+01 | ○ |
| 10 | 60 | 115 | 2.41E+04 | 1.27E+04 | 1.04E+00 | 1.75E+00 | 1.90E+01 | ○ |
| 11 | 60 | 120 | 2.61E+04 | 1.12E+04 | 1.23E+00 | 1.79E+00 | 1.93E+01 | ○ |
| 12 | 60 | 125 | 2.28E+04 | 1.18E+04 | 1.27E+00 | 1.67E+00 | 2.13E+01 | ○ |
| Comparative | — | — | 6.40E+04 | 1.65E+04 | 2.90E+00 | 9.92E−01 | 1.49E+01 | × |
| Example | | | | | | | | |

### Example 8

An extrusion-molded product produced by extrusion molding a protein as a raw material with an extruder was put again into the extruder and extrusion-molded to produce an extrusion-molded product, which was then subjected to an eating evaluation. A powdered protein raw material A (concentrated soybean protein) and a powdered protein raw material B (isolated soybean protein) were used as the protein raw materials. The results are shown in Table 7.

The powdered protein raw material A contained approximately 68% protein, and the powdered protein raw material B contained approximately 90% protein.

### Example 8-1

The powdered protein raw materials A and B were subjected to a low-water content extruder process from 1 to 3 times, after which an eating evaluation was carried out.

### Example 8-2

The powdered protein raw material B was subjected to the low-water content extruder process from 0 to 3 times, and further subjected to the high-water content extruder process, after which an eating evaluation was carried out. The high-water content extruder process was carried out under the conditions of Formulation 2.

### Example 8-3

The powdered protein raw material B was subjected to the low-water content extruder process once and then washed and dehydrated, and was then further subjected to the high-water content extruder process once, and the eating evaluation was conducted. The high-water content extruder process was carried out under the conditions of Formulations 1 to 3, respectively.

Note that the washing and dehydration treatment is a process in which water or hot water is added to the resulting extrusion-molded product, and immersing and stirring are implemented, after which the water content is removed with a sieve or the like, and the product is further dried to remove water until the water content is suitable for the subsequent extruder process.

The low-water content extruder process is a process in which the raw materials and water are put into an extruder, kneaded while being heated and pressurized, and extruded from a die to produce a sponge-like or puff-like extrusion-molded product. In this example, the water content in the kneaded product was set to 30 mass %, and the water content in the extrusion-molded product was set to 15 mass %.

The high-water content extruder process is a process in which the raw materials and water are put into an extruder, kneaded while being heated and pressurized, and then extruded from a cooling die. The formulations and conditions of this example are shown in Table 6.

TABLE 6
Formulations and Conditions of High-
Water Content Type Extruder

| | | | Water | |
|---|---|---|---|---|
| | | | Content | |
| | Content Percentage | | (%) of | Temperature |
| | in Solid Content | | Extrusion- | (° C.) of |
| | Protein | | Molded | Central |
| | (Soybean:Wheat) | Starch | Product | Portion |
| Formulation 1 | 1.0:0.8 | 10% | 50% | 115° C. |
| Formulation 2 | 1.0:1.0 | 10% | 50% | 115° C. |
| Formulation 3 | 1.0:1.2 | 10% | 50% | 115° C. |

TABLE 7

| | | | | Eating |
|---|---|---|---|---|
| | Raw Material | Extruder Process | Washing | Evaluation |
| Example | Powdered | None | None | − |
| 8-1 | protein raw | Low-water content extruder | None | + |
| | material A | process implemented once | | |
| | | Low-water content extruder | None | ++ |
| | | process implemented twice | | |
| | | Low-water content extruder | None | +++ |
| | | process implemented three times | | |
| | Powdered | None | None | − |
| | protein raw | Low-water content extruder | None | + |
| | material B | process implemented once | | |
| | | Low-water content extruder | None | ++ |
| | | process implemented twice | | |
| | | Low-water content extruder | None | +++ |
| | | process implemented three times | | |
| Example | Powdered | High-water content extruder | None | − |
| 8-2 | protein raw | process (Formulation 2) | | |
| | material B | Low-water content extruder | None | + |
| | | process implemented once | | |
| | | ⇒ High-water content extruder | | |
| | | process (Formulation 2) | | |
| | | Low-water content extruder | None | ++ |
| | | process implemented twice | | |
| | | ⇒ High-water content extruder | | |
| | | process (Formulation 2) | | |
| | | Low-water content extruder | None | +++ |
| | | process implemented three | | |
| | | times | | |
| | | ⇒ High-water content extruder | | |
| | | process (Formulation 2) | | |
| Example | Powdered | Low-water content extruder | Yes | +++++ |
| 8-3 | protein raw | process implemented once | | |
| | material B | ⇒ High-water content extruder | | |
| | | process (Formulation 1) | | |
| | | Low-water content extruder | Yes | +++++ |
| | | process implemented once | | |
| | | ⇒ High-water content extruder | | |
| | | process (Formulation 2) | | |
| | | Low-water content extruder | Yes | +++++ |
| | | process implemented once | | |
| | | ⇒ High-water content extruder | | |
| | | process (Formulation 3) | | |

As the results of the eating evaluation, the flavor was determined to be, in decreasing order from an excellent flavor, “+++++”, “++++”, “+++”, “++”, “+”, and “−”. The results are shown in Table 7.

An improvement in flavor was observed as the number of extruder processes increased. In addition, the samples subjected to the washing and dehydration treatment all had a particularly good flavor.

### INDUSTRIAL APPLICABILITY

The present invention can be used for the production of meat-like food products.

### REFERENCE SIGNS LIST

1 Tightly adhered portion
2 Discontinuous portion
A Thickness of tightly adhered portion
B Thickness of tightly adhered portion
C Thickness of tightly adhered portion
H Thickness of meat-like food product

TABLE 6
Formulations and Conditions of High-
Water Content Type Extruder

| | | | Water | |
|---|---|---|---|---|
| | | | Content | |
| | Content Percentage | | (%) of | Temperature |
| | in Solid Content | | Extrusion- | (° C.) of |
| | Protein | | Molded | Central |
| | (Soybean:Wheat) | Starch | Product | Portion |
| Formulation 1 | 1.0:0.8 | 10% | 50% | 115° C. |
| Formulation 2 | 1.0:1.0 | 10% | 50% | 115° C. |
| Formulation 3 | 1.0:1.2 | 10% | 50% | 115° C. |

TABLE 7

| | | | | Eating |
|---|---|---|---|---|
| | Raw Material | Extruder Process | Washing | Evaluation |
| Example | Powdered protein | None | None | − |
| 8-1 | raw material A | Low-water content extruder process | None | + |
| | | implemented once | | |
| | | Low-water content extruder process | None | ++ |
| | | implemented twice | | |
| | | Low-water content extruder process | None | +++ |
| | | implemented three times | | |
| | Powdered protein | None | None | − |
| | raw material B | Low-water content extruder process | None | + |
| | | implemented once | | |
| | | Low-water content extruder process | None | ++ |
| | | implemented twice | | |
| | | Low-water content extruder process | None | +++ |
| | | implemented three times | | |
| Example | Powdered protein | High-water content extruder process | None | − |
| 8-2 | raw material B | (Formulation 2) | | |
| | | Low-water content extruder process | None | + |
| | | implemented once | | |
| | | ⇒ High-water content extruder | | |
| | | process (Formulation 2) | | |
| | | Low-water content extruder process | None | ++ |
| | | implemented twice | | |
| | | ⇒ High-water content extruder | | |
| | | process (Formulation 2) | | |
| | | Low-water content extruder process | None | +++ |
| | | implemented three times | | |
| | | ⇒ High-water content extruder | | |
| | | process (Formulation 2) | | |
| Example | Powdered protein | Low-water content extruder process | Yes | +++++ |
| 8-3 | raw material B | implemented once | | |
| | | ⇒ High-water content extruder | | |
| | | process (Formulation 1) | | |
| | | Low-water content extruder process | Yes | +++++ |
| | | implemented once | | |
| | | ⇒ High-water content extruder | | |
| | | process (Formulation 2) | | |
| | | Low-water content extruder process | Yes | +++++ |
| | | implemented once | | |
| | | ⇒ High-water content extruder | | |
| | | process (Formulation 3) | | |

As the results of the eating evaluation, the flavor was determined to be, in decreasing order from an excellent flavor, “+++++”, “++++”, “+++”, “++”, “+”, and “−”. The results are shown in Table 7.

An improvement in flavor was observed as the number of extruder processes increased. In addition, the samples subjected to the washing and dehydration treatment all had a particularly good flavor.

### INDUSTRIAL APPLICABILITY

The present invention can be used for the production of meat-like food products.

### REFERENCE SIGNS LIST

1 Tightly adhered portion
2 Discontinuous portion
A Thickness of tightly adhered portion
B Thickness of tightly adhered portion
C Thickness of tightly adhered portion
H Thickness of meat-like food product

1. A meat-like food product being free of meat,
wherein
a tissue of the meat-like food product is an oriented fibrous tissue, the tissue includes
a discontinuous portion in which fibers are separated from each other; and
a tightly adhered portion in which fibers are tightly adhered with each other, the tightly adhered portion being around the discontinuous portion, and
the discontinuous portion extends along a fiber direction.

2. The meat-like food product according to claim 1, wherein the tightly adhered portion includes a portion having a thickness from 3 mm to 25 mm in a thickness direction of the meat-like food product.

3. The meat-like food product according to claim 1,
wherein the tissue includes a plurality of the discontinuous portions, and
wherein the tightly adhered portion is present between the surface of the meat-like food product and the discontinuous portion, and between a discontinuous portion and another discontinuous portion of the plurality of discontinuous portions.

4. The meat-like food product according to claim 1, wherein the meat-like food product has a thickness from 6 mm to 50 mm.

5. The meat-like food product according to claim 1, wherein when the meat-like food product is observed in a cross section in a direction perpendicular to the fiber direction, a ratio of the discontinuous portions having a major axis of 3 mm or greater in the cross section among all the discontinuous portions having a major axis of 0.5 mm or greater in the cross section is 10% or greater.

6. The meat-like food product according to claim 1, comprising the discontinuous portion having a major axis of 7.5 mm or greater in a cross section in a direction perpendicular to the fiber direction of the meat-like food product when the meat-like food product is observed in the cross section.

7. The meat-like food product according to claim 1, comprising a plurality of the discontinuous portions.

8. The meat-like food product according to claim 1, wherein the meat-like food product is extrusion-molded by an extruder.

9. The meat-like food product according to claim 1, wherein the discontinuous portion is a void.

10. The meat-like food product according to claim 8, wherein the discontinuous portion is formed through expansion during extrusion molding by the extruder.

11. The meat-like food product according to claim 1, wherein the discontinuous portion is formed by making a cut inside the oriented fibrous tissue.

12. The meat-like food product according to claim 1, wherein the discontinuous portion is formed by laminating two or more protein sheets and partially adhering surfaces of the two or more protein sheets to each other.

13. The meat-like food product according to claim 1, wherein an average value obtained by measuring two or more different points using a Tensipresser satisfies at least one of (A) to (D):
(A) a breaking stress (tenderness) is from 10000 gw/cm² to 47000 gw/cm²;
(B) a total workload (toughness) is from 5000 gw/cm² to 15300 gw/cm²;
(C) a pliability is from 0.5 to 2.1; and
(D) a brittleness is from 1.3 to 3.5,
provided that the measuring two or more different points is according to the following method and conditions:
Sample thickness: a sample is prepared such that the thickness in the direction perpendicular to the fiber direction is 15 mm,
Plunger: cylindrical with diameter q of 5 mm,
Bite Speed: 2.00 mm/sec,
Second Speed: 2.00 mm/sec,
Plansure Area: 0.041 cm²,
Add Value: 0.100 mm,
Measurement temperature: 20° C., and
Measurement method: multiple integration bite method.

14. (canceled)

15. The meat-like food product according to claim 13, wherein at least two of (A) to (D) are satisfied.

16. The meat-like food product according to claim 13, wherein the tissue of the meat-like food is an oriented fibrous tissue, and the meat-like food product has a water content of 50 mass % or greater.

17. A method for producing a meat-like food product according to claim 1, the method comprising:
extrusion molding a kneaded product using an extruder while forcibly cooling to thereby produce an extrusion-molded product, the kneaded product being produced by kneading water and a raw material containing a protein while heating,
wherein,
in the extrusion molding, the extrusion-molded product is forcibly cooled when discharged from the extruder such that a temperature of a central portion of the extrusion-molded product is in a range from 110° ° C. to 125° C., and
the water content of the extrusion-molded product is from 45 mass % to 60 mass % with respect to the total mass of the extrusion-molded product.

18. The method for producing a meat-like food product according to claim 17, wherein, in the extrusion molding, the kneaded product is heated such that a maximum product temperature of the kneaded product is from 145° C. to 180° C.

19. The method for producing a meat-like food product according to claim 17, wherein the water content of the kneaded product is from 45 mass % to 70 mass % with respect to the total mass of the kneaded product.

20. The method for producing a meat-like food product according to claim 17, wherein a ratio of a protein content to a solid content in the kneaded product is from 45 mass % to 90 mass %.

21. The method for producing a meat-like food product according to claim 17, wherein a ratio of a content of starch to the solid content in the kneaded product is from 5 mass % to 20 mass %.

22. The method for producing a meat-like food product according to claim 17, wherein the protein is a plant protein.

23. The method for producing a meat-like food product according to claim 17, wherein the plant protein is soybean protein and/or wheat protein.

24. The method for producing a meat-like food product according to claim 17, wherein,
in the extrusion molding, after the kneaded product is molded into an oriented fibrous tissue, the oriented fibrous tissue is expanded to thereby form, inside the oriented fibrous tissue, a discontinuous portion in which fibers are separated from each other and a tightly adhered portion in which fibers are tightly adhered with each other, the tightly adhered portion being around the discontinuous portion, and
the discontinuous portion extends along a fiber direction.

25-28. (canceled)

29. The meat-like food product according to claim 9, wherein the discontinuous portion is formed through expansion during extrusion molding by the extruder.
